(19) United States
(12) Patent Application Publication
(10) Pub. No.: US 2017/0282174 A1
(43) Pub. Date: Oct. 5, 2017

(54) Tip Collar with Integrated Filters

(71) Applicant: Felix H. Yiu, Covina, CA (US)

(72) Inventor: Felix H. Yiu, Covina, CA (US)

(21) Appl. No.: 14/452,442

(22) Filed: Aug. 5, 2014

(51) Int. Cl. B01L 3/02; B01L 9/00

(52) U.S. Cl. CPC B01L 3/0275; B01L 9/543; B01L 9/50; B01L 2300/0681; B01L 2200/0689; B01L 2200/141

(57) ABSTRACT

A disposable filter tip collar provides an improved system for using filters in conjunction with disposable pipette tips. The filters are installed into the tip-holding collar rather than inside each tip as in current use. The separation of the filters from the tips in this manner offers significant advantages for ease of use, cost, and pipetting performance. Because the filters are separate from the tips, the available liquid pipetting volume within the tips is not diminished as it is using the current system, which allows for more consistent pipetting and method development between filter and non-filter tips. Since the filters are not limited in size by the internal diameter of the pipette tips, larger diameter filters can be used which are more efficient and allow better pipetting performance.

### CROSS-REFERENCE TO RELATED APPLICATIONS

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The present invention is used in the field of small volume liquid pipetting using the air displacement pipetting technique. These air displacement pipettors are used to pipette or aspirate and dispense (transfer) small volumes of liquid, a typical volume range being 1 microliter to 1 milliliter of liquid. A common method for containing the liquid is to use a disposable pipette tip to hold the liquid after it is aspirated and before it is dispensed. The most common material to produce the pipette tips is polypropylene. The advantage of a disposable pipette tip in comparison to a reusable fixed tip is that the liquid being pipetted only comes into contact with the disposable tip, which is discarded after each use thus preventing any carryover or sample-to sample contamination in between pipetting operations. The reusable fixed tips must be washed in between each pipetting operation, and even the washing protocol does not guarantee complete elimination of carryover. Because of this the use of disposable pipette tips is very common for this application.

Air displacement pipettors can be constructed to pipette one liquid sample at a time, or more than one. When more than one sample is pipetted at the same time, this is commonly referred to as a multichannel pipettor. Commonly available multichannel air displacement pipettors may use a number of disposable tips arranged in a single row, or a number of pipette tips arranged in a grid fashion (array pattern). It is a standard in the industry to pipette to and from microtiter plates that have an industry-accepted spacing of liquid containers, or wells. These microtiter plates, also called microplates, commonly have 96 wells arranged in an 8×12 grid or 384 wells arranged in a 16×24 grid. The spacing between wells is defined by the industry-accepted standard. This allows multichannel air displacement pipettors to be constructed that are able to access multiple wells all at once for pipetting, either in a single row or as a grid.

It is an inherent characteristic of the air displacement pipetting technology that when the liquid is aspirated into the tip the liquid will naturally immediately begin to evaporate at the top surface of the liquid within the tip. This evaporation will continue until an equilibrium has been reached within the air column chamber that resides above the top surface of the liquid and below the pipettor mechanism. The amount of solvent evaporation varies depending on the physical characteristics of each particular liquid that is pipetted, but in general the amount of solvent molecules that escape from the liquid is very small. In many applications of pipetting technology this air space of the liquid containing small amounts of evaporated molecules originating from the liquid being pipetted is irrelevant to the experiment being performed, thus no steps are taken to address this issue. However, there is a subset of pipetting where this effect is considered to have a potential negative impact on the experiment being performed, due to the specific nature of the experiment being performed. An example would be applications associated with Polymerase Chain Reaction (PCR) where even a single DNA molecule can impact an experiment negatively if it is inadvertently transferred during a pipetting operation. For these cases, it is common and prior art to install a filter into the upper part of the disposable pipette tip. This filter is constructed of a material that will allow the air pressure within the space between the top of the liquid in the tip and the bottom of the pipettor mechanism to behave the same as if no filter were installed, thereby ensuring that pipetting aspiration and dispensing will take place properly. At the same time, the filter will act as a block to molecules that may escape from the liquid via evaporation, thereby preventing these molecules from traveling upward into the area of the piston chamber above the pipette tip. By using these filters, it is possible to reduce or prevent cross contamination that can occur after one set of tips is used and before the next set of tips is attached for the next pipetting operation. The filter prevents any stray molecules from entering the air space within the pipetting mechanism where they could then travel downward when the pipettor is subsequently used again and potentially contaminate the next liquid sample that is being pipetted.

The prior art method of using a filter that is installed into the top of the disposable pipette tip is effective at preventing the cross-contamination as desired. However, it has a number of limitations that make this method less than ideal.

One limitation is that a filter must be installed into each pipette tip. This is a difficult process step during the production of the pipette tips and therefore adds time and expense to the product.

Another limitation is that the prior art requires the manufacturer to design and manufacture a variety of different filter sizes, which adds complexity and cost to the production process. This is due to the fact that disposable pipette tips are available in a variety of sizes and internal volumes. Common pipette tip sizes range between 30 microliters and 1000 microliters. Each different pipette tip size by nature has a different size opening and internal diameter at the upper part of the tip where the filter is installed, therefore each different volume pipette tip requires a different size filter in order to ensure a proper fit.

Another limitation is that because the filter is installed into the pipette tip, the available volume within the tip is necessarily reduced by the amount of volume taken up by the filter. This reduces the total available capacity of the disposable pipette tip which limits its use in some experiments.

Another limitation is that the prior art requires that the diameter of the filter is limited by the internal diameter of the tip it is installed into. The smaller the diameter of the filter, the less efficient it is at allowing air to pass through due to the limited surface area within the filter itself. Since the nature of air displacement pipetting requires that air pressure above the liquid being pipetted be precisely controlled, this can adversely affect the pipetting precision and accuracy. The effect is worsened for lower-volume pipette tips, which by necessity of their smaller volumes have smaller internal diameters at the top of the tip, which in return reduces the diameter of the filter installed into the top of the tip.

### BRIEF SUMMARY OF THE INVENTION

The present invention is a tip collar that is used to contain a plurality of disposable pipette tips to be used on a multichannel air displacement pipettor. The plurality of tips can be arranged in a single row or in a grid array or in any other pattern suitable for pipetting. This tip collar has a chamber located above each pipette tip that contains a filter. By locating the filter within the tip collar rather than within the top opening of each individual pipette tips, the new and novel design addresses all of the shortcomings of the current prior art. The filters are separated from the pipette tips themselves, therefore the manufacturing process is greatly improved by requiring only one size filter. Additionally, the manufacturer only has to design and produce a single size filter, rather than different sizes for different volume tips. The volume of the pipette tips is not impinged since the filter is separate from the tips. And finally, the diameter of the filter is not limited by the inside diameter of the pipette tip, thus providing more efficient air displacement pipetting operations and better precision and accuracy of the results.

### BRIEF DESCRIPTION OF SEVERAL VIEWS OF THE DRAWINGS

FIG. 1A is a side elevation and cutaway view of a typical prior art air displacement pipettor showing the piston mechanism, the protuberance, and the pipette tip with liquid.

FIG. 1B is another side elevation and cutaway view of the typical prior art air displacement pipettor of FIG. 1A.

FIG. 2A is a side elevation and exploded view of the collar, filters and sealing rings according to one embodiment.

FIG. 2B is a side elevation and exploded view of the collar, filters and sealing rings according to another embodiment.

FIG. 3A is a perspective and cutaway view of the collar, filters and sealing rings according to one embodiment.

FIG. 3B is a perspective and cutaway view of the collar, filters and sealing rings according to another embodiment.

FIG. 4. is a side elevation and cutaway close-up view of the collar with filters installed and pipette tips installed onto the collar.

FIG. 5 is a side elevation cutaway view and cutaway close-up view of the collar with filters installed and pipette tips installed onto the collar, and the collar installed onto a pipettor.

FIG. 6 is a side elevation cutaway view and cutaway close-up view of the collar with filters and rings installed and pipette tips installed onto the collar, and the collar installed onto a pipettor.

### DETAILED DESCRIPTION OF THE INVENTION

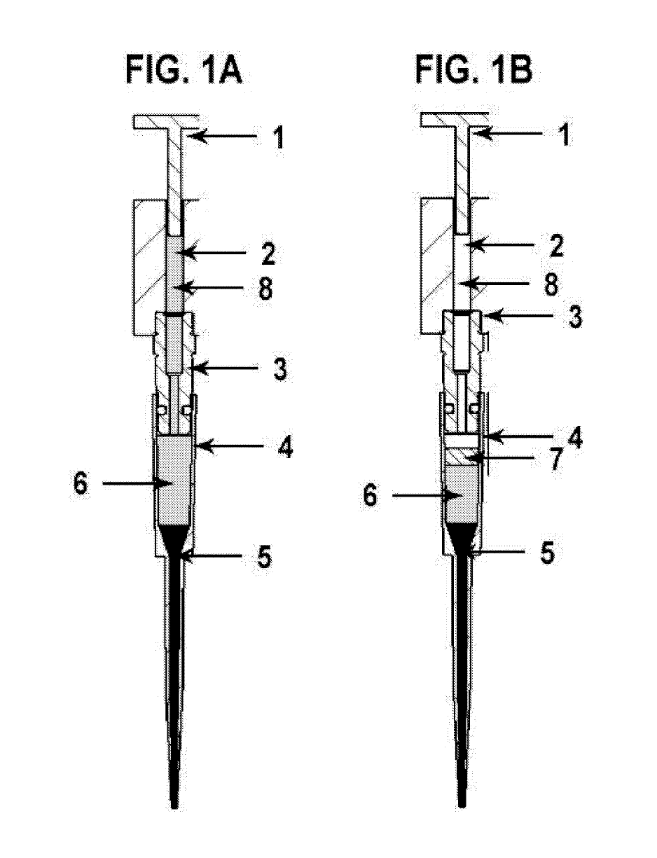

In FIG. 1A a typical volume of liquid 5 (shaded black) is shown after it has been aspirated into the pipette tip 4. A typical pipettor using prior art is shown, with the piston 1 located within a piston chamber 2. The bottom of the piston chamber 2 is fitted with a protuberance 3, onto which the pipette tip 4 is placed by using a downward force applied to the pipettor to effect a seal between the top inside of the pipette tip 4 and the surface of the protuberance 3. The motion of the piston 1 within the piston chamber 2 causes liquid pipetting to occur. When the piston 1 is moved upward, liquid 5 is aspirated into the tip 4. When the piston 1 is moved downward, liquid 5 is dispensed out the bottom of tip 4. After the liquid 5 has been aspirated, evaporation occurs at the top surface of the liquid 5. As evaporation occurs, molecules are free to travel in the pipette tip's air space 6 above the liquid 5 and also into the piston chamber 8. These molecules are also known as aerosols. In this figure the spaces that can be occupied by the aerosols are shaded light gray, including the area in the tip above the liquid 6 and the piston chamber 8. FIG. 1B illustrates the prior art which is the method currently used to place filters in the air displacement column. The filter 7 is installed into the top opening of the pipette tip 4 as shown in FIG. 1B. A single tip 4 is shown in FIG. 1B, but the same concept applies for any number of pipette tips that are assembled together in a plurality for use with a multichannel pipettor. The vertical location of the filter 7 within the tip 4 can vary as currently used in the prior art. When a plurality of pipette tips 4 is used each tip has an individual filter 7 installed into its opening. FIG. 1B shows a typical volume of liquid 5 (shaded black) after it has been aspirated into the pipette tip 4. With the filter 7 installed, aerosols (as indicated by the light gray shading) that escape from the top surface of the liquid 5 cannot pass through the filter 7 and therefore will be confined to the space 6 in the pipette tip between the liquid surface and the filter. No aerosols will travel into the piston chamber 8 where they might remain when the disposable tip 4 is removed in preparation for the next sample.

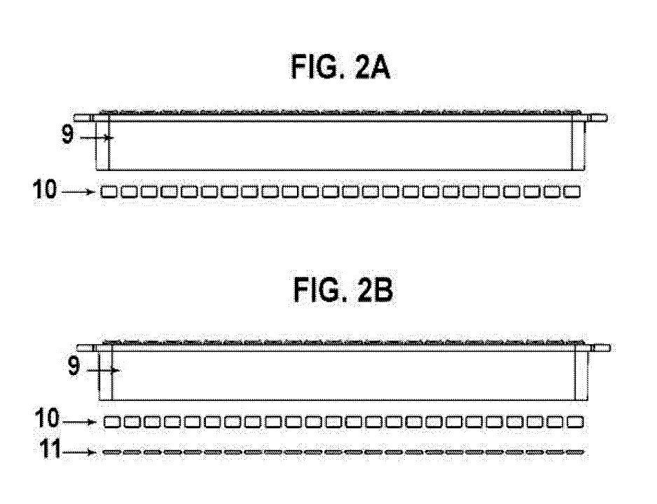

FIGS. 2A and 2B show the tip collar 9 of this invention along with the filters 10 before they have been installed. The new design of this invention is intended to work with various methods of attaching the disposable tips to the tip collar 9. In the first embodiment shown in FIG. 2A the filters 10 are combined with the tip collar 9, and no other sealing mechanism is required if the tips are self sealing. In the second embodiment shown in FIG. 2B a gasket or o-ring 11 is used along with the tips to provide an airtight seal for disposable tips that do not have an integrated self-sealing feature. Through these two embodiments this invention is universally adaptable to any tip attachment technology. The embodiments of this invention are also universally adaptable to any type or style of filter, since different filter materials may be required for different applications.

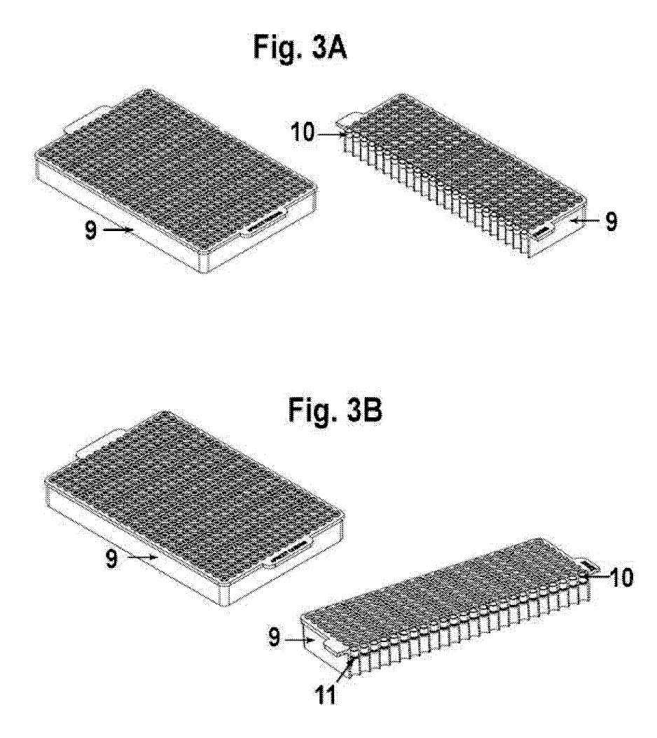

FIGS. 3A and 3B show the tip collar 9 in its assembled and ready to use form with the filters 10 installed within the openings in the tip collar 9, creating an integrated and easy to handle tip collar with integrated filters. FIG. 3A shows the tip collar 9 with filters 10 which is used for self-sealing pipette tips and FIG. 3B shows the alternative embodiment for non-self sealing pipette tips which includes o-rings or gaskets 11 along with the collar 9 and filters 10. In FIGS. 3A and 3B an array of 16×24 filter positions is shown for the collar 9, but the embodiment of this invention is meant to include any number of filter positions arranged in any regular or irregular pattern.

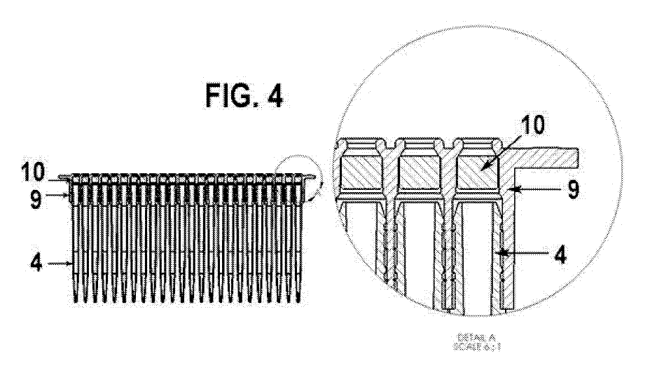

FIG. 4 shows the tip collar 9 with filters 10 after a plurality of disposable pipette tips 4 have been installed onto the tip collar 9. The disposable pipette tips 4 that are assembled onto the head can be the same standard and commonly-used type that are used for non-filter pipetting applications. The same effect as installing the filter into the top of each tip 4 is achieved (as in prior art), but now it is accomplished by separating the filters from the tips 4. The volume of the tips 4 is not reduced or impinged by the filters 10 since the filters 10 are separated from the tips 4.

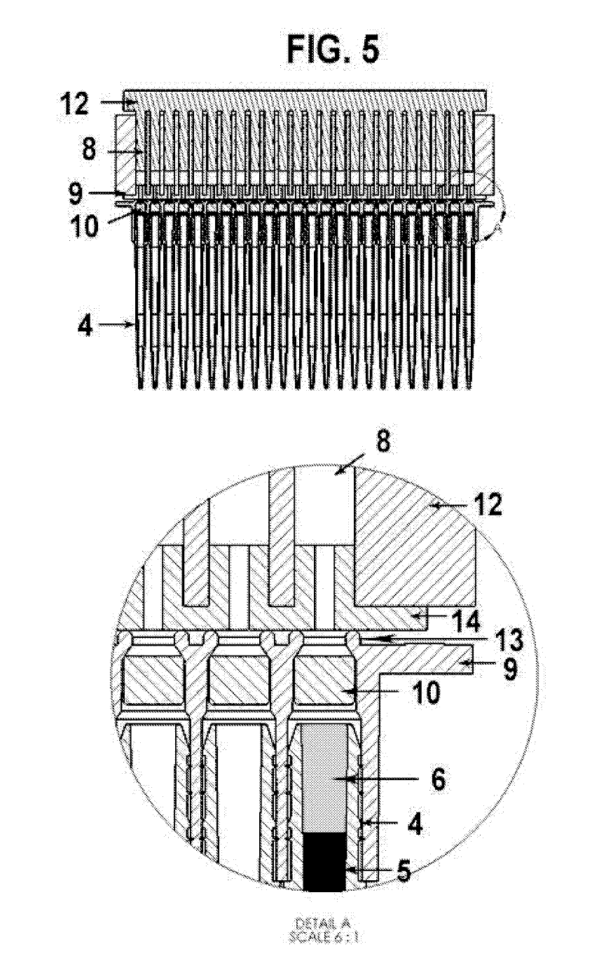

FIG. 5 shows the filter tip collar 9 with tips 4 installed attached to the pipettor 12 for use. When liquid 5 (shaded black) is aspirated into the tips 4, any aerosols (shaded gray) that escape the top surface of the liquid will remain confined in the space 6 between the top surface off the liquid 5 and the filter 10, and they will not enter the air space in the piston chambers 8 since they are blocked by the filters 10. The collar 9 features a raised lip 13 above each filter 10 which mates with a gasket 14 that is installed onto the pipettor 12, thus providing the air tight seal necessary for pipetting. In this embodiment of the invention, the pipette tips 4 have a sealing feature builtin, so when they are installed into the tip collar 9 this sealing feature will create an air tight seal between the tip 4 and the collar 9, which is required for pipetting.

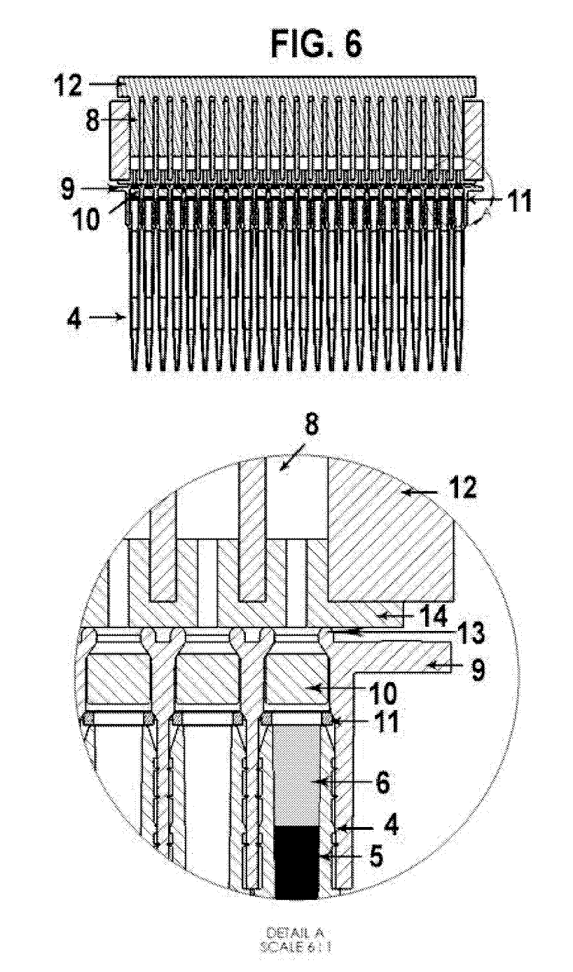

FIG. 6 shows an equivalent embodiment of the invention as shown in FIG. 5, but with the addition of an o-ring or gasket 11 for each disposable tip 4 located between the bottom of the filter 10 and the top of the pipette tip 4. This o-ring or gasket 11 can be made of rubber, silicon, plastic, or any other material that will provide a suitable seal between the tip collar 9 and the tips 4. This embodiment of the invention is designed to work with pipette tips 4 that do not have a sealing feature built-in, allowing this style of tips 4 to be used with the filter collar 9 while maintaining the airtight seal between the tips and the tip collar that is required for pipetting.

The invention is an entirely new and novel way to provide filters for pipette tips which presents significant advantages over the prior art that is currently in common use. One advantage is that unlike the current art, the filters are not placed into the inside of each individual pipette tip. The filters are installed into the filter tip collar and are completely separate from the tips themselves. This simplifies the process of manufacturing disposable pipette filter tips since it is an easier process to install the filters into the collar compared to installing them into the tips. The cost of production also is reduced.

Another advantage is that only one size of filter needs to be designed and manufactured, and this single size filter will function with pipette tips of different sizes. In comparison to prior art where multiple filter sizes are required in order to fit inside pipette tips of various sizes this invention simplifies and improves the manufacturing process and reduces the costs.

Yet another advantage is that the internal volume of the disposable pipette tips is not impinged and reduced by the installation of the filters into the tips. In this invention the tips are separate from the internal volume of the pipette tip, therefore the internal volume of the pipette tips is not reduced, allowing a greater range of volume operations for pipetting.

Yet another advantage is that filter tips of a larger diameter can be used in comparison to prior art. In the prior art where the filter is installed into the inside of the pipette tip, the diameter of the filter is by necessity limited to the inside diameter of the pipette tip at the location where the filter is positioned. With this invention, the filters are contained in a cavity separate from the inside of the pipette tips, so the filters can have a larger diameter. A larger diameter filter contains a higher internal surface area and allows more air to pass through, which improves the pipetting performance as far as precision and accuracy.

1. I claim a disposable filter tip collar consisting of a collar, filters, and o-rings that is used to load a plurality of pipette tips in an evenly-spaced and rigid position.

2. I claim the collar of claim 1 is rigid and has a bottom edge to which a clamping force can be applied in order to load the collar and the tips onto a pipettor, providing enough force to maintain an airtight seal between the tips, and the pipettor.

3. I claim the collar of claim 1 has a plurality of chambers at the top, above the location of the pipette tips. Each of these chambers corresponding to a single pipette tip contains a filter which is designed to block aerosols from traveling from the tip upward into the piston chamber.

4. I claim the collar of claim 1 can optionally contain a sealing o-ring or gasket between the filter chamber and the top of the pipette tip location in order to maintain an air tight seal for the style of pipette tips that does not have a built-in sealing feature.

5. I claim the design of the collar of claim 1 is such that a single size filter can be installed into the collar regardless of the type or size of pipette tip that is loaded onto the collar.
